(19) United States
(12) Patent Application Publication
(10) Pub. No.: US 2011/0154807 A1
(43) Pub. Date: Jun. 30, 2011

(54) NOx TRAP

(75) Inventors: Guy Richard CHANDLER, Cambridge (GB); Elizabeth Hazel MOUNTSTEVENS, Royston (GB); Paul Richard PHILLIPS, Royston (GB); Daniel SWALLOW, Sandy (GB)

(73) Assignee: Johnson Matthey Public Limited Company, London (GB)

(21) Appl. No.: 12/974,528

(22) Filed: Dec. 21, 2010

(30) Foreign Application Priority Data
Dec. 21, 2009 (GB) 0922195.3

(51) Int. Cl. F01N 9/00; B01J 23/63; B01J 21/06; B01J 21/10; B01J 37/02; B01J 37/08; F01N 3/10

(52) U.S. Cl. 60/284; 502/304; 502/303; 60/299

(57) ABSTRACT

A NOx trap comprises components comprising at least one platinum group metal, at least one NOx storage material and bulk ceria or a bulk cerium-containing mixed oxide deposited uniformly in a first layer on a honeycombed substrate monolith, the components in the first layer having a first, upstream, zone having increased activity relative to a second, downstream zone for oxidising hydrocarbons and carbon monoxide, and a second, downstream, zone having increased activity to generate heat during a desulphation event, relative to the first zone, wherein the second zone comprises a dispersion of rare earth oxide, wherein the rare earth oxide loading in the second zone is greater than the loading in the first zone. An exhaust system for a lean burn internal combustion engine, a vehicle comprising a lean burn internal combustion engine and the exhaust system and methods of making the NOx trap are also disclosed.

### CROSS-REFERENCE TO RELATED APPLICATIONS

This application claims priority of British Patent Application No. 0922195.3, filed Dec. 21, 2009, the disclosure of which is incorporated herein by reference in its entirety for all purposes.

### FIELD OF THE INVENTION

The present invention concerns improvements in NOx traps forming part of an internal combustion exhaust gas aftertreatment system, and more especially concerns NOx traps having an improved ability to be regenerated in respect of stored sulphur.

### BACKGROUND OF THE INVENTION

The use of in-line NOx storage units, often called Lean NOx Traps but now more commonly called NOx traps or NOx Absorber Catalysts (NAC), is now well known in exhaust gas aftertreatment systems for lean burn internal combustion engines. Possibly the earliest patent publication is Toyota's EP 0 560 991, which describes how a NOx storage unit may be constructed by incorporating materials such as barium oxide which react with NOx to form nitrates, and a NOx conversion catalyst such as platinum. The trap is periodically regenerated by modulating the fuel/air ratio (commonly called “lambda” or λ) to stoichiometric (λ=1) or rich (λ>1), so that NOx is released and simultaneously reduced by contact with the catalyst to nitrogen gas.

A conventional NOx trap is constructed by depositing NOx trapping components, including oxygen storage components (“OSC”) and catalytic components onto a honeycombed flow-through substrate monolith, in similar manner to coating honeycombed substrate monoliths with an exhaust gas catalyst. We have previously disclosed that, in some circumstances at least, it may be advantageous to form a NOx trap by utilising selected layers of materials.

The present invention may be applied to gasoline, spark ignition engines, but has particular relevance to compression ignition engines, generally known as Diesel engines, though some compression ignition engines can operate on other fuels, such as natural gas, biodiesel or Diesel fuel blended with biodiesel and/or Fischer-Tropsch fuels. Compression ignition engines operate with lean fuel/air ratios, and give good fuel economy, but present greater difficulties than gasoline-fuelled engines in NOx storage and conversion, because of the resulting lean exhaust gases. Gasoline-fuelled engines are generally operated closer to λ=1, and although NOx conversion presents slightly fewer difficulties than with Diesel, sulphur accumulation on, and release from, NOx traps may present some difficulties.

Although Diesel fuels are now commonly refined and formulated as “low sulphur” or “ultra low sulphur”, the fuels, and consequently the exhaust gases, do contain sulphur compounds. The lubricants used in the engine can also contribute sulphur components to the exhaust gases. The NOx traps, which generally contain barium oxides, and ceria as an oxygen storage component (“OSC”), effectively but coincidentally, trap sulphur compounds by reaction. This may be regarded as “poisoning” by sulphur, or simply as reducing the NOx storage capacity of the NOx trap by sulphur competing with the NOx storage sites. As barium sulphate is more stable than barium nitrate in vehicular exhaust gas conditions, sulphur has to be removed periodically using more aggressive (richer, longer and/or hotter exhaust gas temperatures) than are used to release stored NOx. Accordingly, the state of the art NOx storage trap technology includes sulphur release events, in order to maintain the effectiveness of the NOx trap. Such events are periods of operation of the engine such that the sulphur is released from the NOx trap, and generally involve raising the temperature of the NOx trap whilst frequently modulating λ (“lean/rich” switching), which can generate exotherms within the NOx trap. The temperature of the NOx trap in such a sulphur release event is generally increased to at least 550° C.

A number of companies have been working on improving sulphur release from NOx traps, concentrating on initiating and terminating the sulphur release event and the engine management necessary for successful sulphur release. Reference is made to US2009044518 (Peugeot Citroen Automobiles SA) as an example. However, it is not believed that any such improvement made has involved changing the structure of the NOx trap itself. For a typical state of the art NOx trap having a uniform distribution of components throughout, there is a time lag between the front (upstream end) of the NOx trap reaching the desired sulphur release temperature, and the rear of the NOx trap reaching that temperature. In practical terms, therefore, accumulated sulphur is moved through the trap, and there is a tendency for the rear of the trap not to be fully desulphated.

### SUMMARY OF THE INVENTION

The inventors have noted that temperature propagation through the length of a NOx trap substrate is slow. It would therefore be desirable to improve the heat generation in the downstream part of the NOx trap, rather than to rely on conventional heat transfer from the front of the trap during a desulphation event. An aim of the present invention is to realise an improved NOx trap, offering the ability to release trapped sulphur more efficiently and/or with a less demanding desulphation event.

The present invention provides a NOx trap comprising components comprising at least one platinum group metal, at least one NOₓ storage material and bulk ceria or a bulk cerium-containing mixed oxide deposited uniformly in a first layer on a honeycombed substrate monolith, the uniformly deposited components in the first layer having a first, upstream, zone having increased activity relative to a second, downstream zone for oxidising hydrocarbons and carbon monoxide, and a second, downstream, zone having increased activity to generate heat during a desulphation event, relative to the first, upstream, zone, wherein the second, downstream, zone comprises a dispersion of rare earth oxide, wherein the rare earth oxide loading in gin⁻³ in the second, downstream zone is greater than the rare earth oxide loading in the first, upstream zone.

### BRIEF DESCRIPTION OF THE DRAWINGS

In order that the invention may be more fully understood, the following Examples are provided by way of illustration only and with reference to the accompanying drawings, wherein:

FIG. 1 is a graph showing the loss of NOₓ conversion due to repeated SOₓ/deSOₓ cycles plotted against the number of desulphation events at 500° C. on a synthetic catalytic activity test apparatus for two, two-layer lean NOx traps, one having ceria sol present in the bottom layer; and

FIG. 2 is a graph comparing the CO conversion of an 800° C. aged lower-layer of a lean NOx trap with and without ceria sol.

### DETAILED DESCRIPTION OF THE INVENTION

As used herein the term “bulk” to refer to a reducible oxide such as ceria (or any other component) means that the ceria is present as solid particles thereof. These particles are usually very fine, of the order of at least 90 percent of the particles being from about 0.5 to 15 microns in diameter. The term “bulk” is intended to distinguish from the situation in which ceria is “dispersed” on a refractory support material e.g. by being impregnated into the support material from a solution e.g. cerium nitrate or some other liquid dispersion of the component and then dried and calcined to convert the impregnated cerium nitrate to a dispersion of ceria particles on a surface of the refractory support. The resultant ceria is thus “dispersed” onto and, to a greater or lesser extent, within a surface layer of the refractory support. The dispersed ceria is not present in bulk form, because bulk ceria comprises fine, solid particles of ceria. The dispersion can also take the form of a sol, i.e. finely divided particles of e.g. ceria on the nanometer scale.

GB 2450578 discloses a lean NOx trap system comprising two individual substrates wherein an upstream substrate has a lower cerium oxygen storage component and a lower platinum group metal loading than a downstream substrate. However, none of the Examples in GB '578 investigates the benefits claimed of dividing the total ceria loading in the lean NOx trap system between upstream and downstream substrates. Moreover, it is not clear whether by “cerium” in the lean NOx trap the authors intended to mean “bulk” ceria, dispersed ceria or both. In the NOx trap of the present invention, the inventors have found that the presence of “bulk” ceria or a bulk cerium-containing mixed oxide deposited uniformly in a first layer on a honeycombed substrate monolith improves rich NOₓ conversion. By removing it, rich NOₓ conversion is undesirably lower.

US 2004/0082470 discloses a two zone NOx trap that appears to have been designed primarily for use in a gasoline engine, which NOx trap having an upstream zone without oxygen storage component and a downstream zone having “a small amount of mixed oxides of zirconium and cerium”. For the reasons discussed above, the inventors believe that the absence of OSC, e.g. ceria, in the upstream zone would lower the overall NOₓ reduction activity of the NOx trap. Furthermore, the PGM loading in the upstream zone appears to be greater than that of the downstream zone.

In embodiments, the rare earth oxide dispersion can comprise oxides of elements selected from the group consisting of cerium, praseodymium, neodymium, lanthanum, samarium and mixtures thereof. Preferred rare earth oxides include cerium oxide and/or praseodymium oxide with cerium oxide particularly preferred. The rare earth oxide dispersion can be present, for example, as an impregnation of components in the NOx trap (wherein one or more components of the NOx trap supports the rare earth oxide) or as a sol (particles of finely divided rare earth oxide on the nanometer scale).

The inventors have noted that the presence of e.g. dispersed rare earth oxides such as ceria is detrimental to oxidation of HC and CO in e.g. Pt or PtPd/CeZrO₂. They also noted that a key to promoting NOₓ storage is to remove HC and CO from the exhaust gas. As a result of this observation, the skilled person might consider disposing platinum group metal in a higher loading at the inlet end. However, this increases cost to little benefit. Equally, removing platinum group metal from the second, downstream zone entirely is also detrimental to overall NOₓ storage, because total NOₓ storage is catalyst volume-dependent and platinum group metal is required to oxidise NO to NO₂ to promote NOₓ storage. Preferably, therefore, the loading of the dispersion of rare earth oxide in the first, upstream zone in gin⁻³ is zero. However, in certain embodiments e.g. for use in an exhaust system comprising a close-coupled Diesel Oxidation Catalyst followed by a NOx trap in an underfloor location (see also hereinbelow), rare earth oxide can be present also in the first, upstream zone but at a lower loading than the second, downstream zone e.g. at <30%, such as 5-25%, <20% or 10-20% of the loading in gin⁻³ of the dispersion of the rare earth oxide in the second, downstream zone.

By locating most, if not all, of the rare earth oxide dispersion in the second, downstream zone, the hydrocarbon and carbon monoxide oxidation activity of the first, upstream zone is improved relative to the second, downstream zone. Additionally, the rare earth oxide dispersion in the second, downstream zone increases activity to generate heat to promote desulphation during a desulphation event. Also, the inventors believe that the rare earth oxide can generate hydrogen (e.g. via the water gas shift) which can also destabilise sulphate present on the NOx trap, thereby also promoting desulphation.

Depending upon the arrangement most appropriate for use on a vehicle (e.g. maximum exhaust gas temperature, exhaust gas temperature window (i.e. temperature range from high to low), space velocity, location in the exhaust system (close-coupled or underfloor location), the proportions of the first and second zones, by length of the first layer, can be from 20:80 to 80:20, preferably 30:70 to 70:30, especially 50:50.

In further embodiments, the platinum group metals in the uniformly deposited components in the first layer comprise platinum and/or palladium. Combinations of platinum and palladium are preferred as palladium reduces the tendency of platinum to sinter, losing surface area and activity.

The bulk ceria and cerium-containing mixed oxide components are reducible oxides having oxygen storage activity, i.e. in the exhaust gas environment they release oxygen when the exhaust gas is rich of the stoichiometric lambda set point and absorb oxygen from the exhaust gas when the exhaust gas is lean of the stoichiometric lambda set point. A preferred component for combining with cerium in mixed oxides to improve the hydrothermal stability of the bulk cerium oxide is zirconium, and depending upon the ratio of cerium to zirconium used, optionally one or more rare earth elements may also be included.

The or each at least one NOx storage material may be selected from the group consisting of alkaline earth metals and alkali metals. Suitable alkaline earth metals include barium, strontium, calcium and magnesium with barium and/or strontium preferred. Alkali metals may be selected from the group consisting of potassium, caesium, sodium and lithium with potassium and/or caesium preferred.

To improve hydrothermal stability of the NOx trap, it is preferred that the uniformly deposited components in the first layer comprise magnesium aluminate.

To improve NOx reduction at relatively high temperatures and to maintain NOx reduction following hydrothermal ageing, preferably the second layer overlying the first layer comprises a supported rhodium component. The rhodium support can be alumina or zirconia, optionally doped with one or more rare earth elements. Preferably, the support for the rhodium or the washcoat containing the rhodium includes a reducible oxide such as ceria. Where the ceria is not present in the rhodium support, it can be included in the washcoat e.g. as a sol.

To further improve heat management, the second, downstream, zone may have a lower thermal mass than the first, upstream, zone, for example, a lower washcoat loading may be applied.

The honeycombed substrate monolith can be made from a ceramic material such as cordierite or silicon carbide, or a metal such as Fecralloy™. The arrangement is preferably a so-called flow-through configuration, in which a plurality of channels extend in parallel from an open inlet end to an open outlet end. However, the honeycombed substrate monolith may also take the form of a filtering substrate such as a so-called wall-flow filter or a ceramic foam.

According to a further aspect, the invention provides an exhaust system for a lean burn internal combustion engine, which exhaust system comprising a NOx trap according to the invention wherein the first, upstream, zone is oriented to receive exhaust gas from the engine before the second, downstream, zone. The NOx trap according to the invention has particular application when located in the so-called close-coupled position, i.e. within 50 cm or so of the engine exhaust manifold to maximise heat utilisation for promoting catalytic activity. An alternative, less preferred, arrangement would be to locate the NOx trap in the so-called underfloor position, i.e. slung below the vehicle under-body, with a Diesel oxidation catalyst located upstream (optionally close-coupled to the engine) of the underfloor NOx trap. In this latter arrangement it is desirable to disperse some rare earth oxide also in the first, upstream zone, according to the invention.

According to another aspect, the invention provides a vehicle comprising a lean burn internal combustion engine and an exhaust system according to the present invention, wherein the engine comprises engine management means configured, when the engine is in use, intermittently to modulate an engine fuel/air ratio from a normal lean running (lambda<1) mode to a richer running mode (lambda<1, lambda=1 or lambda>1) for the purposes of releasing sulphur inadvertently stored on the NOx trap. The lean burn internal combustion engine of the vehicle is preferably a compression ignition engine, such as a Diesel engine, it can also be fuelled with natural gas, biodiesel or blends of Diesel and biodiesel and/or Fischer-Tropsch-based fuel blends.

According to a further aspect, the invention provides a method of making a NOx trap of the invention, which method comprising the steps of: (a) coating a honeycombed substrate monolith with a uniform washcoat comprising at least one platinum group metal, at least one NOx storage material and bulk ceria or a bulk cerium-containing mixed oxide; (b) drying and firing the coated substrate monolith; (c) impregnating a second zone of the coated substrate monolith with an aqueous solution of a rare earth element; or contacting a second zone of the coated substrate monolith with a sol of a rare earth element oxide; and (d) drying and firing the coated substrate monolith of step (c).

In one embodiment, an additional step is inserted between steps (c) and (d), wherein a first zone of the coated substrate monolith is impregnated with an aqueous solution of a rare earth element; or a first zone of the coated substrate monolith is contacted with a sol of rare earth element oxide, and in either case the resulting rare earth oxide loading in gin⁻³ (i.e. excluding the bulk ceria or bulk cerium-containing mixed oxide) in the first zone is: (i)<30% the rare earth oxide loading in the second zone; or (ii)>70% the rare earth oxide loading in the second zone.

According to another aspect, the invention provides a method of making a NOx trap according to the invention, which method comprising the steps of: (a) coating a first zone of a honeycombed substrate monolith from a first end with a washcoat comprising at least one platinum group metal, at least one NOx storage material and bulk ceria or a bulk cerium-containing mixed oxide; (b) drying and firing the part-coated substrate monolith; (c) coating a second zone of the part-coated substrate monolith from a second end thereof with a washcoat comprising at least one platinum group metal, at least one NOx storage material, bulk ceria or a bulk cerium-containing mixed oxide and an aqueous solution of a rare earth element or a sol of a rare earth element oxide; and (d) drying and firing the coated substrate monolith of step (c).

In one embodiment, the washcoat of step (a) comprises an aqueous solution of rare earth element or a sol of a rare earth element oxide at a concentration resulting in a rare earth oxide loading in gin⁻³ (i.e. excluding the ceria or cerium-containing mixed oxide) in the first, upstream, zone that is: (i) <30% the rare earth oxide loading in the second zone; or (ii) >70% the rare earth loading in the second zone.

In embodiments of either method of making a NOx trap according to the present invention, a further step comprises of coating the substrate monolith coated with the first layer with a second layer comprising a supported rhodium component and drying and firing the resulting substrate monolith.

The first and second zones may be readily formed by utilising known techniques for differential deposition of catalyst and other components for exhaust gas catalysts, for example using the Applicant's WO 99/47260, i.e. comprising the steps of (a) locating a containment means on top of a support, (b) dosing a pre-determined quantity of a liquid component into said containment means, either in the order (a) then (b) or (b) then (a), and (c) by applying pressure or vacuum, drawing said liquid component into at least a portion of the support, and retaining substantially all of said quantity within the support.

### EXAMPLES

### Example 1

### Lean NOx Trap Formulation

A 400 cells per square inch flow-through cordierite substrate monolith was coated with a two layer NOx trap formulation comprising a first, lower layer comprising 2 gin⁻³ alumina, 2 gin⁻³ particulate ceria, 90 gft⁻³ Pt, 25 gft⁻³ Pd and 800 gft⁻³ Ba and a second layer comprising 0.5 gin⁻³ 85 wt % zirconia doped with rare earth elements, 10 gft⁻³ Rh and 400 gft⁻³ ceria sol. The first layer was coated on the virgin substrate monolith using the method disclosed in WO 99/47260 followed by drying for 30 minutes in a forced air drier at 100° C. and then by firing at 500° C. for 2 hours before the second layer was applied and the same drying a firing procedure was repeated. This NOx trap was labelled LNT1.

LNT2 was prepared using an identical procedure except in that 400 gft⁻³ ceria sol was also added to the lower layer formulation.

### Example 2

### Synthetic Catalytic Activity Test (SCAT) repeat SOₓ/deSOₓ Test

A core was cut from each of LNT1 and LNT2 and each core was tested in turn using on a Synthetic Catalytic Activity Test (SCAT) apparatus using the following conditions:

1) Cycle between 300 seconds lean/20 seconds rich at an inlet temperature of 350° C.
5 cycles with no sulphur to evaluate clean NOx performance; and
5 cycles with sulphur to sulphate sample to 2 g/litre

2) Desulphate at 500° C. for 5 minutes
Cycle between 50 seconds rich/10 seconds lean

3) 300 seconds lean/20 seconds rich at 350° C.
5 cycles with no sulfur to evaluate desulfated NOx performance; and
5 cycles with sulfur to sulfate to 2 g/l

4) Repeat

The gas conditions used are set out in Table 1.

TABLE 1

| | | | Lean | Rich |
|---|---|---|---|---|
| | Lean | Rich | desulphation | desulphation |
| Length (secs) | 300 | 20 | 10 | 50 |
| NO (ppm) | 100 | 200 | — | — |
| CO (%) | 0.03 | 2 | 1 | 2 |
| CO₂ (%) | 6 | 10 | 6 | 10 |
| C₃H₆ (ppm) | 50 | 1700 | 50 | 1700 |
| H₂ (%) | 0 | 0.4 | 0 | 0.4 |
| O₂ (%) | 11 | 1.5 | 6 | 1.5 |
| H₂O (%) | 12 | 12 | 6.6 | 12 |
| Flow rate | 47 | 39 | 47 | 39 |
| (l/min) | | | | |

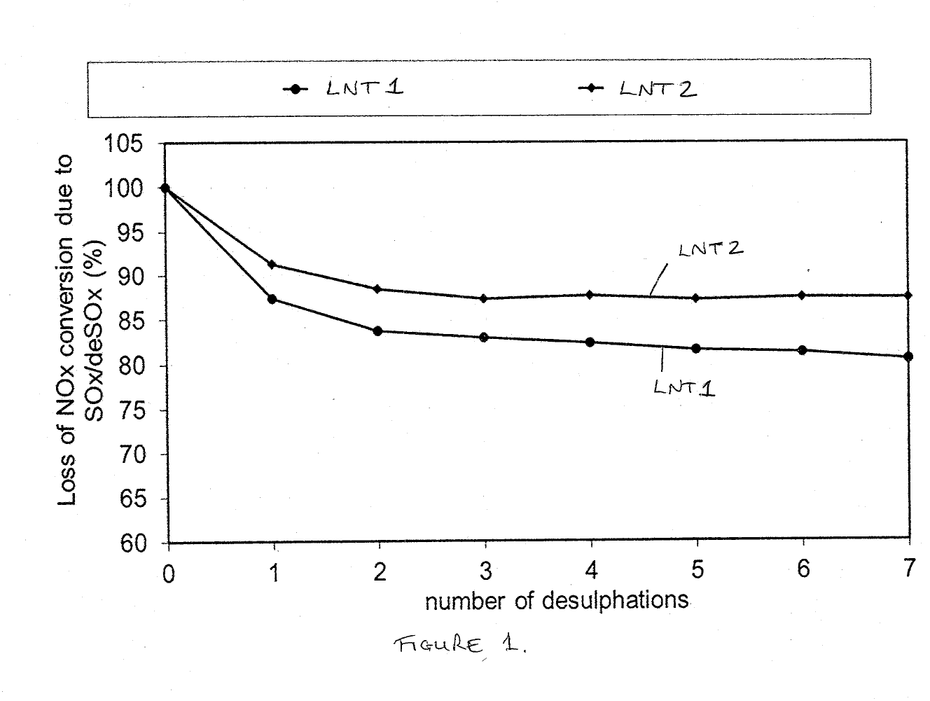

The results of repeated sulphation/desulphation cycles and its effect on NOₓ conversion is shown in FIG. 1, in which it can be seen that after repeated desulphations, LNT2 retains more NOₓ conversion activity than LNT1. That is, the presence of additional dispersed ceria in the lower layer of LNT2 assists in retaining NOₓ conversion after repeated SOₓ/deSOₓ cycles. The inventors infer from this observation that the dispersed ceria assists in desulphation by generating an exotherm and/or hydrogen during the desulphation events that assists in desulphating the NOx trap.

### Example 3

### NOx Trap Lower Layer CO Oxidation Activity

Substrate monoliths coated with the lower layers only of LNT1 and LNT2 following drying and firing prepared as described in Example 1 were aged at 800° C. for 5 hours in 10% H₂O, 10% O₂, balance N₂. The substrate monoliths were each tested on a laboratory bench-mounted 1.9 litre Euro 4 Diesel engine by removing an existing NOx trap and replacing it with the LNT1 (lower layer) or LNT2 (lower layer) substrate monoliths.

An engine speed of 1200 rpm was selected and the engine torque was varied to achieve a desired catalyst inlet temperature. The evaluation started with a catalyst inlet temperature of 350° C. The engine torque was adjusted to ramp the inlet temperature down to <150° C., sufficient to achieve carbon monoxide oxidation “light-out”. In practice this was done by reducing the engine torque from 100 Nm to 5 Nm over 10 minutes. Following “light-out”, the engine torque was ramped back up at a rate of approximately 7° C./min to 350° C. to achieve carbon monoxide oxidation “light-off”. Exhaust gas composition, mass flow rate, temperature etc. were all monitored using a vehicle dynamometer.

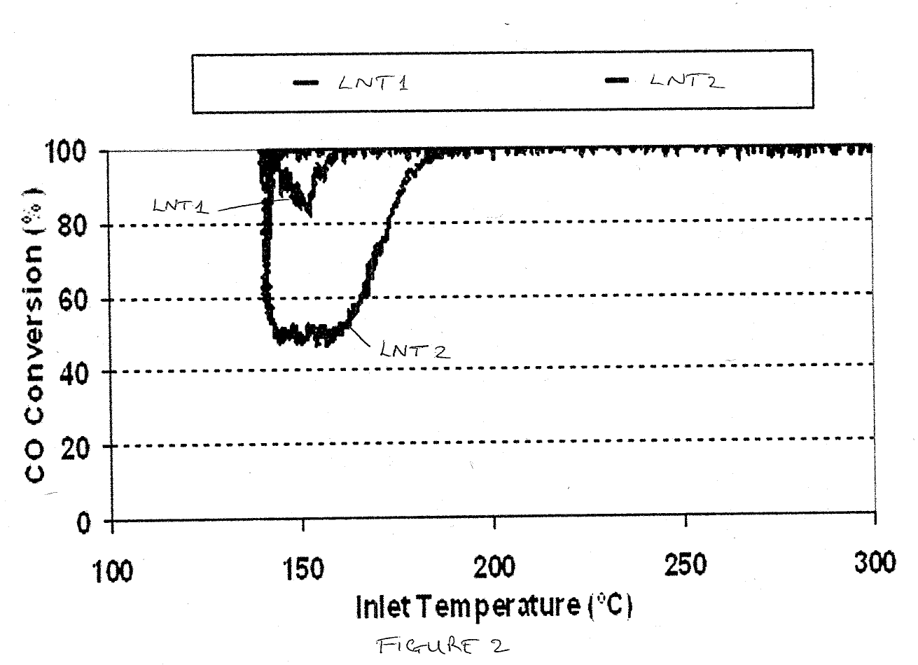

The results of CO conversion (%) for this test procedure are shown in FIG. 2, from which it can be seen that after lighting out at <150° C., the catalyst's CO oxidation activity “lights off” again as the test ramps up above about 165° C. and the CO conversion activity of LNT1 lower layer never drops below 80% conversion over the entire test. However, after the CO conversion activity of the LNT2 lower layer, which contains ceria sol in addition to the other washcoat components of LNT1, lights-out at <150° C., the catalyst fails to light-off again to a similar degree as the LNT1 lower layer until about 180° C., and CO conversion efficiency falls to below 50%.

The results of Examples 1, 2 and 3 taken together show that for a lean NOx trap comprising Pt, Pd, and a barium NOₓ storage component supported on alumina and bulk ceria, the presence of dispersed ceria is both detrimental to CO conversion activity and beneficial to desulphation. By “zoning” the dispersed ceria to the rear of a substrate monolith carrying the NOₓ trap, an advantageous combination of functionalities is obtained.

For the avoidance of any doubt, the entire contents of every patent document referenced herein is incorporated herein by reference.

1. A NOx trap comprising components comprising at least one platinum group metal, at least one NOₓ storage material and bulk ceria or a bulk cerium-containing mixed oxide deposited uniformly in a first layer on a honeycombed substrate monolith, the uniformly deposited components in the first layer having a first, upstream, zone having increased activity relative to a second, downstream zone for oxidising hydrocarbons and carbon monoxide, and a second, downstream, zone having increased activity to generate heat during a desulphation event, relative to the first, upstream, zone, wherein the second, downstream, zone comprises a dispersion of rare earth oxide, wherein the rare earth oxide loading in gin⁻³ in the second, downstream zone is greater than the rare earth oxide loading in the first, upstream zone.

2. A NOx trap according to claim 1, wherein the rare earth oxide dispersion comprises oxides of elements selected from the group consisting of cerium, praseodymium, neodymium, lanthanum, samarium and mixtures thereof.

3. A NOx trap according to claim 1, wherein the loading of the dispersion of rare earth oxide in the first, upstream, zone in gin⁻³ is in the range 0-30% of the loading of the dispersion of the rare earth oxide in the second, downstream, zone.

4. A NOx trap according to claim 1, wherein the proportions of the first and second zones, by length of the first layer, are from 20:80 to 80:20.

5. A NOx trap according to claim 1, wherein the platinum group metals in the uniformly deposited components in the first layer comprise at least one of platinum and palladium.

6. A NOx trap according to claim 1, wherein the bulk cerium-containing mixed oxide comprises zirconium and optionally one or more rare earth elements.

7. A NOx trap according to claim 1, wherein the or each at least one NOₓ storage material is selected from the group consisting of alkaline earth metals and alkali metals.

8. A NOₓ trap according to claim 1, wherein the uniformly deposited components in the first layer comprise magnesium aluminate.

9. A NOx trap according to claim 1, wherein a second layer overlying the first layer comprises a supported rhodium component.

10. A NOx trap according to claim 1, wherein the second zone has a lower thermal mass than the first zone.

11. A NOₓ trap according to claim 1, wherein the honeycombed substrate monolith is a flow-through honeycombed substrate monolith.

12. An exhaust system for a lean burn internal combustion engine, which exhaust system comprising a NOx trap according to claim 1 wherein the first, upstream, zone is oriented to receive exhaust gas from the engine before the second, downstream, zone.

13. A vehicle comprising a lean burn internal combustion engine and an exhaust system according to claim 12, wherein the engine comprises engine management means configured, when the engine is in use, intermittently to modulate an engine fuel/air ratio from a normal lean running (lambda<1) mode to a richer running mode (lambda<1, lambda=1 or lambda>1) for the purposes of releasing sulphur inadvertently stored on the NOx trap.

14. A method of making a NOₓ trap, said method comprising the steps of:
a. coating a honeycombed substrate monolith with a uniform washcoat comprising at least one platinum group metal, at least one NOₓ storage material and bulk ceria or a bulk cerium-containing mixed oxide;
b. drying and firing the coated substrate monolith;
c. impregnating a second zone of the coated substrate monolith with an aqueous solution of a rare earth element; or contacting a second zone of the coated substrate monolith with a sol of a rare earth element oxide; and
d. drying and firing the coated substrate monolith of step c.

15. A method according to claim 14, wherein between steps c. and d. a first zone of the coated substrate monolith is impregnated with an aqueous solution of a rare earth element; or a first zone of the coated substrate monolith is contacted with a sol of rare earth element oxide, and in either case the resulting rare earth oxide loading in gin⁻³ in the first zone is: (i) <30% the rare earth oxide loading in the second zone; or (ii) >70% the rare earth oxide loading in the second zone.

16. A method of making a NOₓ trap, said method comprising the steps of:
a. coating a first zone of a honeycombed substrate monolith from a first end with a washcoat comprising at least one platinum group metal, at least one NOₓ storage material and bulk ceria or a bulk cerium-containing mixed oxide;
b. drying and firing the part-coated substrate monolith;
c. coating a second zone of the part-coated substrate monolith from a second end thereof with a washcoat comprising at least one platinum group metal, at least one NOₓ storage material, bulk ceria or a bulk cerium-containing mixed oxide and an aqueous solution of a rare earth element or a sol of a rare earth element oxide; and
d. drying and firing the coated substrate monolith of step c.

17. A method according to claim 16, wherein the washcoat of step a. comprises an aqueous solution of rare earth element or a sol of a rare earth element oxide at a concentration resulting in a rare earth oxide loading in gin⁻³ in the first zone that is: (i) <30% the rare earth oxide loading in the second zone; or (ii) >70% the rare earth oxide loading in the second zone.

18. A method according to claim 14, further comprising the step of coating the substrate monolith coated with the first layer with a second layer comprising a supported rhodium component and drying and firing the resulting substrate monolith.

19. A method according to claim 16, further comprising the step of coating the substrate monolith coated with the first layer with a second layer comprising a supported rhodium component and drying and firing the resulting substrate monolith.
